(19) United States
(12) Patent Application Publication
(10) Pub. No.: US 2026/0098615 A1
(43) Pub. Date: Apr. 9, 2026

(54) METHOD FOR DETERMINING INSTRUCTION FOR A CORROSION MONITORING LOCATION

(71) Applicant: MATRIX JVCO LTD trading as AIQ, Abu Dhabi (AE)

(72) Inventors: Zaynab HABIBI, Abu Dhabi (AE); Mouna ZAIDANI, Abu Dhabi (AE); Umar ASIF, Abu Dhabi (AE); Mohamed AMRI, Abu Dhabi (AE); Rachid BELMESKINE, Abu Dhabi (AE); Al Tenaiji BADER, Abu Dhabi (AE); El Sinnary OMAR, Abu Dhabi (AE); Kumar SURESH, Abu Dhabi (AE); Giridhar Y.V., Abu Dhabi (AE); Al Zaabi HUSSA, Abu Dhabi (AE)

(73) Assignee: MATRIX JVCO LTD trading as AIQ, Abu Dhabi (AE)

(21) Appl. No.: 19/115,069

(22) PCT Filed: Sep. 30, 2022
(86) PCT No.: PCT/IB2022/059354

§ 371 Date: Mar. 25, 2025

(51) Int. Cl. F17D 5/02; G06F 30/17

(52) U.S. Cl. CPC F17D 5/02; G06F 30/17

(57) ABSTRACT

A computer-implemented method for determining an operating instruction for a corrosion monitoring location (CML) comprises the steps of receiving input data describing a current corrosion state of the CML, predicting, by a first artificial intelligence (AI) model, a future corrosion visual state of the CML using at least a first part of the input data, predicting, by a second AI, model, a future corrosion severity state of the CML using at least a second part of the input data, determining, by a third AI, model, a future corrosion type of the CML based at least on the future corrosion visual state of the CML, and determining an operating instruction for the CML based on the future corrosion visual state of the CML, the future corrosion severity state of the CML and the future corrosion type of the CML.

### FIELD OF THE INVENTION

The present disclosure relates to a computer-implemented method, a data processing device and a computer program for determining an operating instruction for a corrosion monitoring location. In addition, the present disclosure relates to a training method of artificial intelligence models for use in determination of an operating instruction for a corrosion monitoring location.

### BACKGROUND

In oil and gas industry, equipment is placed as the highest priority for operations. Many failures and equipment damage in a facility associated with pressure vessels and piping systems lead to billions of dollars'loss and has impacts on the oil and gas transportation and distribution, and the environment.

In oil and gas industry, equipment's components are prone to corrosion triggered by various factors. Specifically, piping and pressure vessels are subject to various failure mechanisms since they are typically used in several processes and severe environment conditions. Corrosion affecting the pressure vessels and piping systems lead to a weakening of the equipment strength and integrity and therefore affecting the capacity to resist the variation in temperature and pressure generated towards the vessel systems or the piping.

Corrosion left undetected may lead to serious safety concerns and environmental damage such as production loss, environmental impacts, transportation disruptions, injuries, and fatalities. Hence, identifying and detecting corrosion has proven to be important.

Corrosion Condition Monitoring Locations, CMLs, are designated areas on pressure static equipment and piping where periodic external examination is conducted in order to directly assess the condition of the equipment and piping. CML may contain one or more examination points to give a high probability of detection and utilize multiple inspection techniques such as the use of manual ultrasonic thickness (UT) instruments to collect data on remaining wall thickness of steel piping, tanks and pressure vessels. In addition, predicting the behavior of corrosion and its severity has always been a challenge, resulting in unnecessary inspections for equipment and piping, whereas, these inspections should be, instead, based on corrosion behavior predictions of individual CMLs.

The type of metal employed in a certain pressure vessels or piping affects the corrosion behavior and the corrosion growth rate. Moreover, the nature of medium contacting the metal, the process parameters such as the pressure and the temperature within the pipe or vessel, beside other operating and environmental factors, also play a role on corrosion behavior. Corrosion is the primary risk of pressure vessels and piping reliability. If not correctly monitored, and in case of cracks or leakage, corrosion can present a major risk for the environment and human life. Accordingly, for many years, oil and gas industries have acknowledged that it is necessary to monitor the condition of pressure vessels and piping in the plant. One way of achieving this is predicting the corrosion state.

Feng Jiang et al.: “A GAN-Augmented Corrosion Prediction Model for Uncoated Steel Plates” state that corrosion is a long-term process ant it is time-consuming to determine the degree of corrosion based on observations. However, the time-based dynamic simulation is not sufficient and only provides a rough prediction model. Its accuracy is also far from applicable for simulating corroded surfaces. The current issues with corrosion prediction are the low prediction accuracy and the specificity of the environment and steel. In order to solve this problem, Feng Jiang et al. present a solution based on the use of a generative adversarial network (GAN) to predict the corrosion of specific uncoated steel structures.

However, the proposed solution is based on specific structures and circumstances and does not consider the prediction of corrosion behavior of individual Condition Monitoring Locations, CMLs, nor the optimization of CMLs inspections.

Against this background, there is a need for an accurate and reliable method for determining an operating instruction for a CML for an efficient optimization of CML inspections for repair or maintenance.

### SUMMARY OF THE INVENTION

The above-mentioned problem is at least partly solved by a computer-implemented method according to aspect 1, by a computer-implemented method according to aspect 12, by a data processing device according to aspect 20 and a computer program according to aspect 21.

A 1^{st} aspect of the present invention refers to a computer-implemented method for determining an operating instruction for a corrosion monitoring location (CML), the method comprising the steps of: receiving input data describing a current corrosion state of the CML; predicting, by a first artificial intelligence (AI) model, a future corrosion visual state of the CML using at least a first part of the input data; predicting, by a second AI, model, a future corrosion severity state of the CML using at least a second part of the input data; determining, by a third AI, model, a future corrosion type of the CML based at least on the future corrosion visual state of the CML; and determining an operating instruction for the CML based on the future corrosion visual state of the CML, the future corrosion severity state of the CML and the future corrosion type of the CML.

Determining an operation instruction based on input data describing a current corrosion state of the CML, which comprises predicting of a future corrosion visual state, a future corrosion severity state and a future corrosion type of the CML allows to accurately determine the operating instruction for the CML. This is because the determination considers specific models and real data describing the current corrosion state. This may lead to improved operation instruction determination.

According to a 2^{nd} aspect in the 1^{st} aspect, the first part of the input data comprises visual data of the current corrosion state of the CML; and/or the second part of the input data comprises measurement data of the current corrosion state of the CML.

A prediction of a future corrosion visual state of the CML based on visual data of the current corrosion state of the CML and a prediction of a future corrosion severity state of the CML based on measurement data of the current corrosion state of the CML allows to ensure accurate predicting of a future corrosion visual state, a future corrosion severity state and a future corrosion type of the CML, as well as better determination of an operating instruction for the CML.

According to a 3^{rd} aspect in the 2^{nd} aspect, the visual data comprises time-series data of images taken from the CML; the measurement data comprises time-series data of a thickness of the CML; and a first image of visual data of the CML is associated with a first thickness of the measurement data of the CML; a second image of visual data of the CML is associated with a second thickness of the measurement data of the CML; and a timestamp of the first image is older than a timestamp of the second image and a timestamp of the first thickness is older than a timestamp of the second thickness.

Time-series data of images taken from the CML and time-series data of a thickness of the CML with a first and second images respectively associated with a first and a second thickness and considering that a timestamp of the first image is older than a timestamp of the second image and that a timestamp of the first thickness is older than a timestamp of the second thickness allows for a more accurate prediction of a future corrosion visual state, a future corrosion severity state and a future corrosion type of the CML as well as better determination of an operating instruction for the CML.

According to a 4^{th} aspect in the 3^{rd} aspect, the method further comprises processing at least one of the images to identify at least one region of interest in the image.

Processing at least one image of the time-series data of images to identify at least one region of interest in the image allows to enhance useful highlights in the image and to suppress the unwanted background of the image.

According to a 5^{th} aspect in the 3^{rd} and 4^{th} aspects, predicting the future corrosion visual state of the CML is based on predicting a third image of the CML for a future timestamp, predicting the future corrosion severity state of the CML is based on predicting a third thickness of the CML for the future timestamp, and the third image is associated with the third thickness.

Predicting the future corrosion visual state and the future corrosion severity state of the CML may be respectively based on predicting an image and a thickness for a future timestamp compared to the timestamp of the first and second images of the visual data and of the first and second thicknesses of the measurement data of the CML.

According to a 6^{th} aspect in any one of the 1^{st} to 5^{th} aspects, a third part of the input data comprises information on at least one of a location of the CML; a component type of the CML; a material type and/or a material grade of the CML; a minimum and nominal thickness of the CML; a short-term corrosion rate of the CML; a long-term corrosion rate of the CML; a corrosion behavior associated with the CML; a timepoint of an end of product lifecycle of the CML; time-series chemical composition data of a process fluid in contact with the CML; time-series operating data of the CML; design parameters of the CML; and/or an initial fluid phase of a fluid in contact with the CML.

Detailed information as input data about the CML may provide additional information about the pipeline construction and its associated impact on the corrosion behavior. Therefore, including this information may lead to an improvement of the prediction of a future corrosion severity state as well as to a better determination of an operating instruction for the CML.

According to a 7^{th} aspect in the 5^{th} and 6^{th} aspects, predicting the future corrosion severity state of the CML is further based on predicting a corrosion growth rate of the CML for the future timestamp using at least the second part of the input data, the third image is associated with the corrosion growth rate.

Predicting the future corrosion severity state of the CML may be based on predicting a corrosion growth rate. The predicted corrosion growth rate allows for a better determination of an operating instruction for the CML.

According to an 8^{th} aspect in any one of the 1^{st} and 7^{th} aspects, the CML comprises an area on pressure static equipment and piping.

According to a 9^{th} aspect in any one of the 1^{st} to 8^{th} aspect, determining the operating instruction may comprise determining a risk assessment based on the future corrosion visual state of the CML, the future corrosion severity state of the CML and the future corrosion type of the CML and triggering an alarm when the risk assessment is above a defined risk threshold.

Determining a risk assessment and triggering an alarm when the risk assessment is above a defined risk threshold allows to avoid critical equipment failure.

According to a 10^{th} aspect in any one of the 1^{st} to 9^{th} aspect, determining the operating instruction may comprise determining at least one timestamp for a future action for the CML based on the future corrosion visual state of the CML, the future corrosion severity state of the CML and the future corrosion type of the CML.

Determining at least one timestamp for a future action for the CML allows to optimize inspection schedules and/or repairing schedules as well as to improve resource usage in terms of efficiency (e.g., efficient scheduling of inspections).

According to a 11^{th} aspect in any one of the 1^{st} to 10^{th} aspect, determining the operation instruction is done by using a recommendation system.

A 12^{th} aspect refers to a computer-implemented method for training a first artificial intelligence model, a second artificial intelligence model and a third artificial intelligence model for use in determination of an operation instruction for a corrosion monitoring location, CML, the method comprising: receiving training data to train the first artificial intelligence model, the second artificial intelligence model and the third artificial intelligence model. The training data at least comprises: a first part of the training data including visual data of at least one CML, the first part of the training data being used to train the first artificial intelligence model to predict a future corrosion visual state; a second part of the training data including measurement data of the at least one CML, the second part of the training data being used to train the second artificial intelligence model to predict a future corrosion severity state; and a third part of the training data including visual data associated with corrosion type data of the at least one CML, the third part of the training data being used to train the third artificial intelligence model to predict a future corrosion type.

According to a 13^{th} aspect in the preceding aspect, the visual data is represented by time-series data of images taken from the at least one CML; the measurement data is represented by time-series data of a thickness of the at least one CML; the visual data is represented by time-series data of images taken from the at least one CML, each image being associated with a corrosion type of the corrosion type data.

According to a 14^{th} aspect in the preceding aspect, the images of the visual data are associated with a corrosion severity state and are grouped according to the associated corrosion severity state.

According to a 15^{th} aspect in any one of the 12^{th} or 14^{th} aspect, the second part of the training data further comprises at least one of a location of the CML; a component type of the CML; a material type and/or a material grade of the CML; a minimum and nominal thickness of the CML; a short-term corrosion rate of the CML; a long-term corrosion rate of the CML; a corrosion behavior associated with the CML; a timepoint of an end of product lifecycle of the CML; time-series chemical composition data of a process fluid in contact with the CML; time-series operating data of the CML; and/or an initial fluid phase of a fluid in contact with the CML.

According to a 16^{th} aspect in any one of the 1^{st} to 11^{th} aspect, the first AI model, the second AI model and the third AI model have been trained according to the method of any one of the 12^{th} to 15^{th} aspect.

According to a 17^{th} aspect in any one of the 1^{st} to 11^{th} and 16^{th} aspect, the method comprises determining that new training data is available and training the models according to the method of any one of the 12^{th} to 15^{th} aspect using the new input data.

According to a 18^{th} aspect in any one of the 1^{st} to 17^{th} aspect, the first AI model, the second AI model and the third AI model are implemented respectively by a generative adversarial network, a machine learning regressor and a machine learning classifier.

According to a 19^{th} aspect in any one of the 1^{st} to 18^{th} aspect, the future corrosion type is at least one of metal loss, pitting, dent or crack.

A 20^{th} aspect refers to a data processing device comprising means configured to perform a method according to the 1^{st} to 11^{th} or 12^{th} to 19^{th} aspect.

A 21^{st} aspect refers to a computer program comprising instructions, which when executed by a computer, causes the computer to carry out a method according to the 1^{st} to 11^{th} or 12^{th} to 20^{th} aspect.

### BRIEF DESCRIPTION OF THE DRAWINGS

Various aspects of the present invention are described in more detail in the following by reference to the accompanying figures without the present invention being limited to the embodiments of these figures.

FIG. 1 illustrates an overview of the algorithm according to aspects of the present invention.

FIG. 2 illustrates a flow chart of a method for determining an operating instruction for a corrosion monitoring location, CML, according to aspects of the present invention.

FIG. 3 illustrates an output of a prediction of a future corrosion visual state, a future corrosion severity state and a future corrosion type of a CML based on input data describing a current corrosion state of the CML according to aspects of the present invention.

FIG. 4 illustrates a prediction of a future corrosion visual state of the CML.

FIG. 5 illustrates an output of a method for determining an operating instruction for a corrosion monitoring location, CML, according to aspects of the present invention.

FIG. 6 illustrates visual data grouped according to the associated corrosion severity state.

FIG. 7 illustrates an overview of the improved workflow according to aspects of the present invention.

### DETAILED DESCRIPTION

In the following, certain aspects of the present invention are described in more detail.

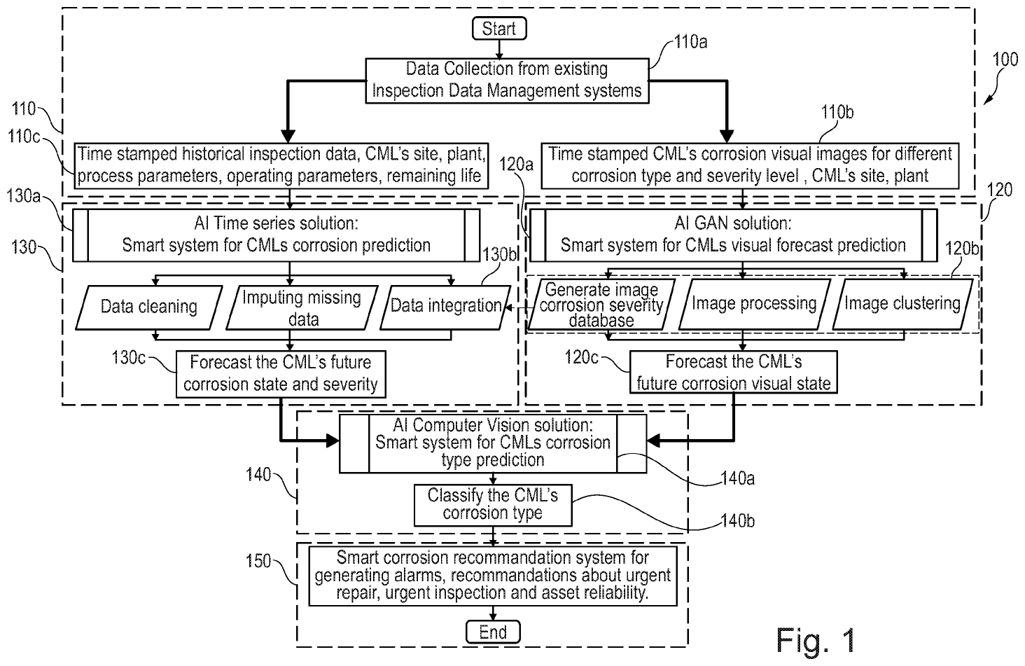

FIG. 1 illustrates an overview of an algorithm 100 according to aspects of the present invention used for efficiently and accurately determining an operating instruction for a corrosion monitoring location (CML). The algorithm 100 is based on input data 110 and two different workflows, namely a first artificial intelligence (AI) workflow 120 and a second artificial intelligence workflow 130. In addition, following the two AI workflows, the algorithm continues with a third AI workflow 140 and a determination of an operating instruction for the CML 150.

The input data 110 on which the algorithm operates is referred to as input data describing a current corrosion state of the CML 110a. The CML for which an operating instruction is to be determined is associated with a corrosion state. The input data describing a current corrosion state of a CML 110a may represent a data collection from one or more existing systems, such as inspection data management systems.

While the first and the second AI workflows 120 and 130, and possibly the third AI workflow 140 operate on the input data, it is possible that each workflow only operates on certain parts of the input data.

For example, the first AI workflow 120 may only use a part of the input data (e.g., comprising visual data of the current corrosion state of the CML) as input 110b. The input data may be inputted into a first AI model 120a for predicting a future corrosion visual state of the CML 120b-c.

The second AI workflow 130 may use another part of the input data (e.g., comprising measurement data of the current corrosion state of the CML) as input 110c to predict a future corrosion severity state of the CML 130c. In addition, the AI workflow 130 may also use (at least a part of) the image 120b generated by the first AI workflow 120 (indicated by the dotted arrow from the first AI workflow 120 on the right side to the second AI workflow 130 on the left side) as input 130b. The corresponding input data may be input into a second AI model 130a for predicting a future corrosion severity state of the CML. The future corrosion severity state of the CML may include a thickness of the CML and/or a corrosion growth rate of the CML.

The output of the first AI workflow 120, i.e., the future corrosion visual state of the CML, may be used as input to the third AI workflow 140. In particular, the future corrosion visual state of the CML may be inputted into a third AI model 140a for determining (e.g., classifying) a future corrosion type (e.g., comprising at least one of metal loss, pitting, dent or crack) of the CML 140b.

Based on the information provided by the three AI workflows (e.g., the future corrosion visual state, the future corrosion severity state and the future corrosion type of the CML), an operating instruction for the CML may be determined 150.

The operating instruction for the CML may comprise one or more actions or recommendations to optimize CML inspection schedules and to understand the behavior patterns of corrosion and its impact.

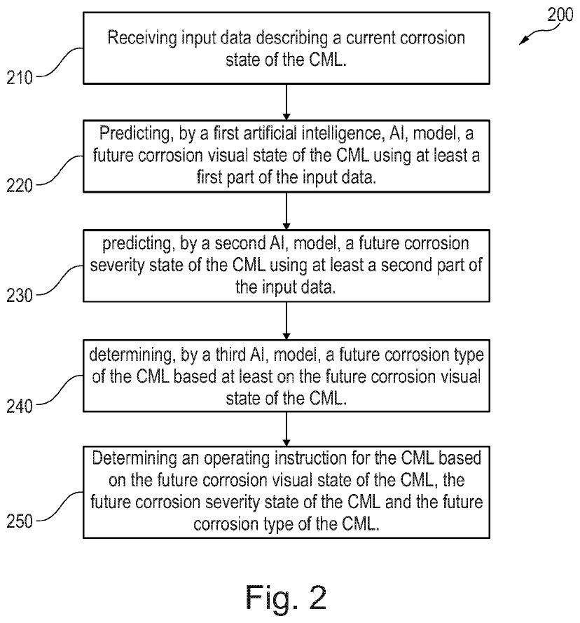

FIG. 2 illustrates a flow chart of a method 200 for determining an operating instruction for a corrosion monitoring location, CML, according to aspects of the present invention. The method 200 may be based on the algorithm 100. In step 210, input data describing a current corrosion state of the CML may be received. Step 220 may refer to the first AI workflow 120 of the algorithm 100. The first AI model in the first AI workflow 120 used for predicting a future corrosion visual state of the CML may be a generative adversarial network, GAN, model. The future corrosion visual state of the CML predicted by the first AI model may be based on at least a first part of the input data. Step 230 may refer to the second AI workflow 130 of the algorithm 100. The second AI model in the second AI workflow 130 used for predicting a future corrosion severity state of the CML may be a machine learning regressor model. The future corrosion severity state of the CML predicted by the second AI model may be based on at least a second part of the input data.

The first part of the input data may comprise visual data of the current corrosion state of the CML, and the second part of the input data may comprise measurement data of the current corrosion state of the CML. The visual data and the measurement data of the current corrosion state of the CML may be obtained during a physical inspection of the CML and may comprise real visual data of the CML (e.g., an image) and physical inspection measurements.

The visual data of the current corrosion state of the CML may comprise time-series data of images taken from the CML, and the measurement data of the current corrosion state of the CML may comprise time-series data of a thickness of the CML. A first image of the visual data of the CML may be associated with a first thickness of the measurement data of the CML, a second image of the visual data of the CML may be associated with a second thickness of the measurement data of the CML. A timestamp of the first image may be older than a timestamp of the second image and a timestamp of the first thickness may be older than a timestamp of the second thickness

The time-series data of images and of a thickness of the CML allows to determine corrosion development information. Determining the corrosion development information may be done by comparing a historical corrosion feature from a first physical inspection to the corrosion feature from a second physical inspection, wherein the first physical inspection was conducted prior to the second physical inspection. This means that the corrosion development of a single historical corrosion feature is determined by comparing it at two different points in time. Therefore, comparing the second image and the first image taken from the CML at different timestamps and comparing the second thickness and the first thickness measured at these different timestamps may provide the information about the development of the corrosion of the CML (e.g., corrosion growth rate, a wall metal loss, a thickness evolution).

The time-series data of images and of a thickness of the CML may be used to determine a corrosion development information and allows for a more accurate prediction of a future corrosion visual state and of a future corrosion severity state. In particular, the first and the second AI models may also use the corrosion development information (e.g., corrosion growth rate, a wall metal loss, a thickness evolution) to predict a future corrosion visual state and a future corrosion severity state of the CML in a more accurate manner.

At least one image of the time-series data of images may be processed to identify at least one region of interest in the image to enhance useful highlights in the image and to suppress the unwanted background of the image. This allows for a more efficient use of resources for a prediction of a future corrosion visual state of the CML and a determination of an operating instruction for the CML.

Predicting a future corrosion visual state of the CML by the first AI model may be based on predicting a third image of the CML for a future timestamp (i.e., the future timestamp of the third image being older than the timestamp of the second image) and predicting a future corrosion severity state of the CML by the second AI model may be based on a third thickness of the CML for the future timestamp (i.e., the future timestamp of the third thickness being older than the timestamp of the second thickness). The third image of the CML for the future timestamp may be associated with the thickness of the CML for the future timestamp.

The input data may also comprise a third part comprising information on at least one of a location of the CML (e.g., comprising the CML's identification site and/or plant), a component type of the CML, a material type and/or a material grade of the CML, a minimum and nominal thickness of the CML, a short-term corrosion rate of the CML, a long-term corrosion rate of the CML, a corrosion behavior associated with the CML, a timepoint of an end of product lifecycle of the CML, time-series chemical composition data of a process fluid in contact with the CML (e.g., H₂S concentration and/or H₂O content percentage), time-series operating data of the CML, design and/or operating parameters of the CML (e.g., pressure, temperature, allowable stress, flow stress), and/or an initial fluid phase of a fluid in contact with the CML (e.g. liquid, gas).

The future corrosion severity state of the CML predicted by the second AI model may in addition be based on the third part of the input data.

Predicting the future corrosion severity state of the CML may in addition or alternatively be based on predicting a corrosion growth rate of the CML for the future timestamp using the second part of the input data and/or the third part of the input data. The third image of the CML for the future timestamp may also be associated with the predicted corrosion growth rate of the CML for the future timestamp.

Step 240 may refer to the third AI workflow 140 of the algorithm 100. The third AI model used for determining (e.g., classifying) a future corrosion type of the CML may be a machine learning classifier model. The future corrosion type of the CML determined by the third AI model may be based on at least the future corrosion visual state of the CML. The future corrosion type may comprise at least one of metal loss, pitting, dent or crack.

The future corrosion visual state, the future corrosion severity state and the future corrosion type of the CML enable to identify the corrosion mechanism and to predict the reliability of the component structure in terms of its probability of failure or lifetime estimation.

Step 250 may determine an operating instruction for the CML based on the future corrosion visual state, the future corrosion severity state and the future corrosion type of the CML predicted by the three AI models.

The operating instruction for the CML may comprise one or more actions to perform, recommendations or information to understand the corrosion development (e.g., corrosion growth rate, a wall metal loss, a thickness evolution) and its impact. The operating instruction for the CML may, in addition or alternatively, comprise one or more maintenance measures to be taken (e.g., repairing or replacing equipment) on the CML.

Determining of operating instruction may comprise determining a risk assessment based on the future corrosion visual state, the future corrosion severity state and the future corrosion type of the CML and triggering an alarm when the risk assessment is above a defined risk threshold to avoid critical equipment failure. Triggering alarm may be done for example when the thickness of the future corrosion severity state of the CML reaches the minimum required threshold. The alarm may be displayed on a graphic interface user of an operator. The alarm may be accompanied by a description of one or more actions to be taken to solve the problem.

Determining of operating instruction may comprise determining at least one timestamp for a future action for the CML based on the future corrosion visual state, the future corrosion severity state and the future corrosion type of the CML to optimize inspection schedules and/or repairing schedules enabling the operator to optimize individual CMLs inspection intervals without jeopardizing process safety and integrity of plant assets.

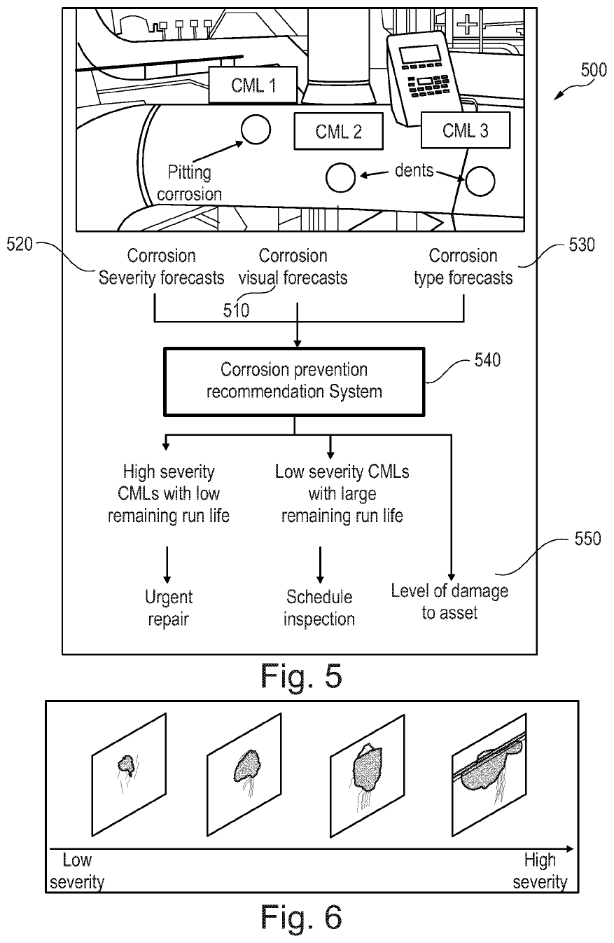

Determining the operation instruction for the CML may be done by using a recommendation system as illustrated in FIG. 5.

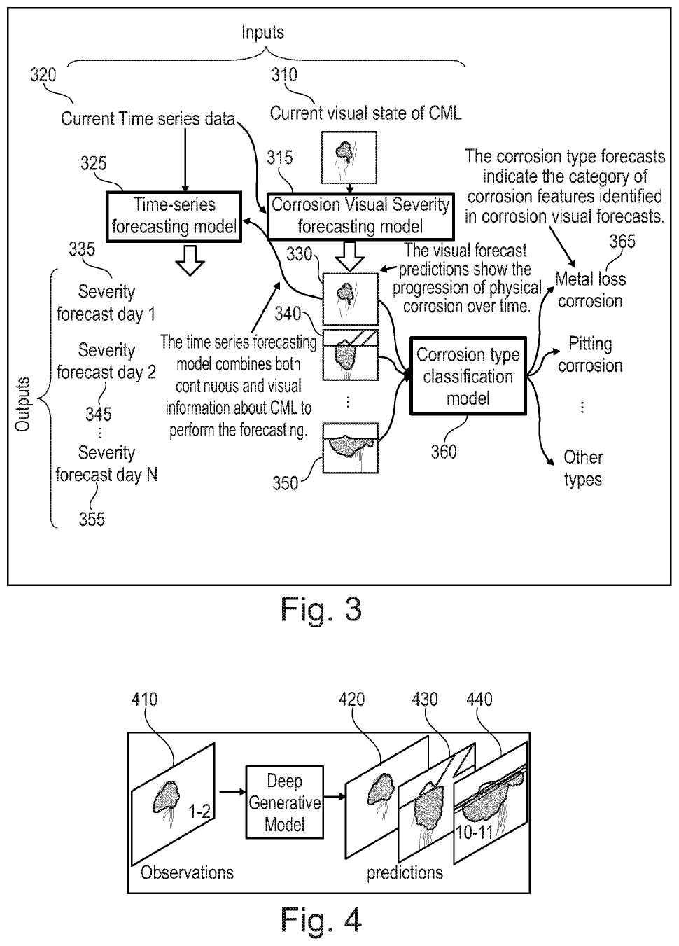

FIG. 3 illustrates an output of a prediction/determination of a future corrosion visual state, a future corrosion severity state and a future corrosion type of a CML based on input data describing a current corrosion state of the CML according to aspects of the present invention. A prediction of a future corrosion visual state, of a future corrosion severity state and of a future corrosion type of the CML may be based on the algorithm 100. Input data may comprise visual data 310 and measurement data 320 of current corrosion state of the CML. As illustrated, the visual data 310 may include at least one image taken from the CML. The visual data 310 may be used as input to the first AI model 315 for predicting a future corrosion visual state of the CML. The future corrosion visual state of the CML may include a visual state of the CML for a future timestamp, for example for day 1, the visual state may be a predicted image of the CML 330. The future corrosion visual state of the CML may include time-series data for example of predicted images of the CML, for future timestamps, for example for day 2, until day N 340, 350 to perform the forecasting of the development of physical characteristics of corrosion over time.

FIG. 4 illustrates a future corrosion visual state of a CML comprising time-series data of images of the CML for future timestamps 420, 430, 440 predicted by the first AI model (e.g., a generative adversarial network) based on a current visual state of the CML 410 including an image taken from the CML. As illustrated, a time-series data of images of the CML for future timestamps allows to show the future corrosion behavior.

The future corrosion visual state of the CML comprising time-series data of images of the CML 330, 340 and 350 may be analyzed by the third AI model 360 to determine (or classify) a future corrosion type 365 of the CML. A future corrosion visual state of the CML comprising time-series data of predicted images of the CML allows a better determination (or classification) of the future type of corrosion of the CML. The future corrosion type determined may be at least one of metal loss, pitting, dent or crack.

The measurement data 320 of current corrosion state of the CML may be used as input to the second AI model 325 for predicting a future corrosion severity state of the CML. The future corrosion severity state of the CML may include a corrosion severity state of the CML for a future timestamp 335, for example for day 1, the corrosion severity state may be a predicted thickness of the CML 335. The future corrosion severity state for the future timestamp day 1 may be associated with the future corrosion visual state for the same future timestamp. The future corrosion severity state of the CML may include a time-series data for example of a predicted thickness of the CML, for future timestamps, for example for day 2, until day N 345, 355 to perform the forecasting of the development of the severity of the physical characteristics of corrosion over time. Each of the predicted image may be associated with a predicted thickness for the same future timestamp.

FIG. 5 illustrates an output of a method for determining an operating instruction for a corrosion monitoring location, CML, based on a future corrosion visual state, a future corrosion severity state and a future corrosion type of the CML according to aspects of the present invention. The determining of an operating instruction for a CML 500 may be based on the algorithm 100. A future corrosion visual state 510, a future corrosion severity state 520 and a future corrosion type of the CML 530 may be used as input to a recommendation system 540 to determine an operating instruction for the CML 550. The operating instruction 550 may comprise determining damage level (high severity, medium severity, low severity) and recommendation for fix or repair. The operating instruction may in addition or alternatively comprise at least one timestamp for a future action for the CML and/or determining a risk assessment and triggering an alarm when the risk assessment is above a defined threshold. Triggering alarm may be done for example when the thickness of the CML reaches the minimum required threshold of thickness and may occur according to a time period determined (for example 36 months advance) before that the predicted thickness of the CML may reach the minimum required threshold.

The first AI model, the second AI model and the third AI model used for determining an operation instruction for a CML may be trained according to a computer-implemented method for training respectively the first, the second and the third model for determining an operation instruction for a CML according to aspects of the present invention. Such a method may comprise the step of receiving training data to train the first AI model, the second AI model and the third AI model. The training data may at least comprise: a first part of the training data including visual data of at least one CML, the first part of the training data being used to train the first AI model to predict a future corrosion visual state, a second part of the training data including measurement data of the at least one CML, the second part of the training data being used to train the second AI model to predict a future corrosion severity state, and a third part of the training data including visual data associated with corrosion type data of the at least one CML, the third part of the training data being used to train the third AI model to predict a future corrosion type.

The visual data of the first part of the training data may be represented by time-series data of images (i.e., each visual data being time-stamped). Each image may be an image taken from the at least one CML (for a given time stamp) for example during a physical inspection. The measurement data of the second part of the training data may be represented by time-series data of a thickness of the at least one CML. Each thickness may be a measurement performed from the at least one CML (for a given time) for example during a physical inspection. The visual data may be represented by time-series data of images taken from the at least one CML, each image may be associated with a corrosion type of the corrosion type data. The corrosion type may comprise at least one of metal loss, pitting, dent or crack.

The images of the visual data may be associated with a corrosion severity state and may be grouped according to the associated corrosion severity state as illustrated in FIG. 6.

Therefore, during training, the first AI model is trained to predict a future corrosion visual state (e.g., a visual data for time-stamp t+1) based on visual data of at least one CML of time-stamp t. Accordingly, once the first AI model is trained, it can then predict a future corrosion visual state of a CML based on a (current) visual data of the CML. The second AI model is trained to predict a future corrosion severity state (e.g., a measurement data for time-stamp t+1) based on measurement data of the at least one CML of time-stamp t. Accordingly, once the second AI model is trained, it can then predict a future corrosion severity state of the CML based on a (current) measurement data of the CML. The third AI model is trained to predict a future corrosion type (e.g., a corrosion type for time-stamp t+1) based on visual data associated with corrosion type data of the at least one CML of time-stamp t. Accordingly, once the third AI model is trained, it can then determine a future corrosion type of the CML based on the future corrosion visual data of the CML.

The second part of the training data may further comprise at least one of a location of the CML; a component type of the CML; a material type and/or a material grade of the CML; a minimum and nominal thickness of the CML; a short-term corrosion rate of the CML; a long-term corrosion rate of the CML; a corrosion behavior associated with the CML; a timepoint of an end of product lifecycle of the CML; time-series chemical composition data of a process fluid in contact with the CML; time-series operating data of the CML; and/or an initial fluid phase of a fluid in contact with the CML.

While during application of the trained AI models, the future corrosion visual state, the future corrosion severity state and the future corrosion type of a CML to be predicted are unknown, the future corrosion visual state, the future corrosion severity state and the future corrosion type of the CML during training are known to be able to optimize the model. Therefore, the corresponding future corrosion visual state of the CML may correspond to visual data of the CML having a future time stamp obtained during a physical inspection and the future corrosion severity state of the CML may correspond to measurement data of the CML having the future time stamp obtained during the physical inspection and the future corrosion type of the CML may correspond to corrosion type of the CML having the future time stamp obtained during the physical inspection.

The training data may comprise inspection data obtained from a physical inspection. Accordingly, the above-mentioned data (e.g., visual data, measurement data) of the training data may be associated with a corresponding time-stamp of a corresponding physical inspection. In some embodiments, the training data may continuously be updated once new input data or training data is available. For example, should new inspection measurements and corrosion images from a newly conducted physical inspection provide new inspection measurements and corrosion images, the new inspection measurements and corrosion images may be added to the existing training data.

In fact, during inspection, the monitoring of corrosion may use monitoring techniques including radiography using a radioactive source and radiosensitive film or using ultrasonic probes for acoustic monitoring. These techniques allow the monitoring of the remaining wall thickness of pressure vessels and piping even when the plant is fully operational. This monitoring is performed in some CMLs which each may contain one or more examination points in order to inspect piping only at selected locations, using the most suitable inspection technique based on the defined corrosion mechanisms to give the highest probability of detection. Generally, two different locations or inspection points from a piping equipment exposed to the same corrosion environment, and similar other factors and parameters, will present a similar corrosion behavior. Therefore, the corrosion measurement taken at a given specific location of an equipment during an inspection may be used to monitor the corrosion behavior for another location of the equipment. Therefore, such measurement data obtained during inspections are used to train the AI models.

The training data may also include a data collection from one or more existing systems such as inspection data management systems. The historical data may also include at least one of the following information: site, area and functional location, component type, component material, in particular material type and/or material grade, time stamped historical measurements, corrosion rate, component minimal thickness, component nominal thickness, a timepoint of an end of product lifecycle of the component (e.g., component old remaining life), component old thickness, location of the component, component site, component operating parameters and component process parameters, chemical composition data of the product flowing through the components (e.g., chemical composition data of a process fluid in contact with the component). The training data may therefore improve the accuracy of the prediction since many information may be correlated and affect the corrosion severity, in particular the growth rate.

For validating the accuracy of the first, the second and the third AI models, the training data may be split into a training set (e.g., 80% of the plurality of data samples) and a test set (e.g., 20% of the plurality of data samples). Once the AI models are trained on the training set, their prediction accuracy are determined on the test set. Based on the prediction accuracy it may be determined whether the training is finished or further optimization is required. In particular, the second AI model may be a machine learning regressor which may use training set to train regressor so that it may predict for test input data.

Determining the prediction accuracy is done by putting a data sample of the test set for a CML (e.g., a measurement data and visual data for a given time stamp i) into the AI models and receiving a future corrosion visual state of the CML, a future corrosion severity state of the CML and a future corrosion type of the CML predicted by the AI models as well an operating instruction determined from the predictions for a follow up timestamp i+n, wherein n may represent a selected time for which the future corrosion visual state of the CML, the future corrosion severity state of the CML and the future corrosion type of the CML are to be predicted. For example, if a timestamp of the measurement data and visual data is the year 2013 (i.e., i=2013) and one wants to predict a future corrosion visual state, a future corrosion severity state and a future corrosion type of the CML and determine an operating instruction for the CML for the year 2015, n equals 2 years (i.e., 2013+2=2015). The value of n may be variable. The future corrosion visual state, the future corrosion severity state and the future corrosion type of the CML may then be validated using a follow up data sample (i.e., a measurement data and a visual data for the given time-stamp). In the example, the future corrosion visual state, the future corrosion severity state and the future corrosion type of the CML for the year 2015 would be validated against the actual inspection measurement data and visual data of the year 2015. If the difference between the future corrosion visual state, the future corrosion severity state and the future corrosion type of the CML and the actual inspection of the CML comprising measurement data and visual data, is within a certain threshold, the prediction quality of the AI models may be sufficiently high and thus the training of the AI models may be finished. The threshold may be an 85% accuracy (or 5% error). The difference may be determined for example by comparing a future corrosion visual state of the CML (e.g., image predicted) with the corresponding visual data of the actual corrosion state of the CML (e.g., image taken from the CML) and by comparing a future corrosion severity state of the CML (e.g., measurement data predicted) with the corresponding measurement data of the actual corrosion state of the CML. This may be done for all pairs of corrosion state (i.e., a future corrosion state including a future corrosion visual state and a future corrosion severity state and the corresponding (historical) corrosion state including an historical corrosion visual state and a historical corrosion severity state). The prediction quality may then be determined using all comparison results. In particular, it may be validated that the future corrosion severity state including a thickness is within a threshold to determine the level of accuracy of the prediction quality.

As already mentioned, the data of the inspection comprising measurement data and visual data may be continuously updated. Therefore, once an update has been conducted the AI models may be retrained. Before training the AI models, preprocessing (e.g., treatment of missing values etc.) of the training data may be conducted.

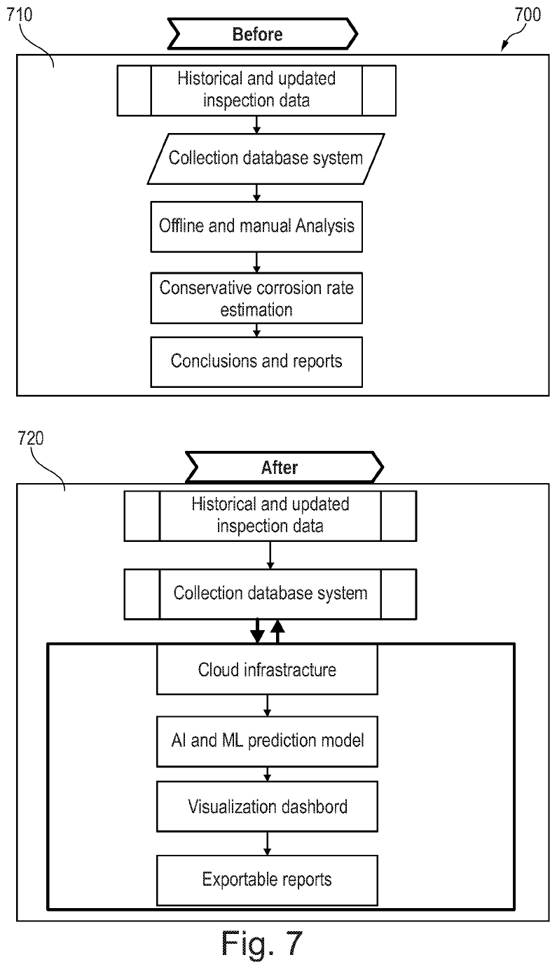

FIG. 7 illustrates an overview 700 of the improved workflow according to aspects of the present invention. FIG. 7 illustrates a “Before” workflow 710, which is used for corrosion prediction without using the present invention, and an “After” workflow 720, which is used for corrosion prediction according to aspects of the present invention.

As one can see at the top of FIG. 7, in the “Before” workflow 710, data from historical and updated inspections and from a collection database system are used for an offline and (mostly) manual analysis. The data may for example be stored in excel sheets or other data sources. Using conservative corrosion rate estimation techniques, conclusions about the corrosion are drawn and bundled in a report (e.g., in Word or PDF format). However, this workflow 710 does not provide interactive data visualization and determining an operating instruction for the CML like scheduling inspection or maintenance measures.

As one can see at the bottom of FIG. 7, the “After” workflow 720 provides this functionality. Data from historical and updated inspections and from a collection database system ensures that all necessary data is continuously aggregated and provided for the cloud infrastructure. This may include pre-processing (e.g., data cleaning like removing missing not-a-number (NAN-)s or not-available data, correct inconsistencies like typos; impute and/or interpolate missing data). This may allow to identify and check the data integrity and if needed suggest error handling of suspect data (e.g., suspect data may be a negative corrosion growth rate between two following inspections). Based on that data, the new workflow 720 enables to determine an operating instruction for the CML based on a future corrosion visual data, a future corrosion severity state and a future corrosion type of the CML using the method 200 of the present invention. Corresponding results and insights may then be displayed on an interactive dashboard. Corresponding reports may be exported from a cloud system.

The aspects according to the present invention may be implemented in terms of a computer program which may be executed on any suitable data processing device comprising means (e.g., a memory and one or more processors operatively coupled to the memory) being configured accordingly. The computer program may be stored as computer-executable instructions on a non-transitory computer-readable medium.

Embodiments of the present disclosure may be realized in any of various forms. For example, in some embodiments, the present invention may be realized as a computer-implemented method, a computer-readable memory medium, or a computer system.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computing device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. In particular, with reference to the appended claims, features from dependent claims may be combined with those of the independent claims and features from respective independent claims may be combined in any appropriate manner and not merely in the specific combinations enumerated in the appended claims.

1. A computer-implemented method for determining an operating instruction for a corrosion monitoring location, CML, the method comprising the steps of:
receiving input data describing a current corrosion state of the CML;
predicting, by a first artificial intelligence, AI, model, a future corrosion visual state of the CML using at least a first part of the input data;
predicting, by a second AI, model, a future corrosion severity state of the CML using at least a second part of the input data;
determining, by a third AI, model, a future corrosion type of the CML based at least on the future corrosion visual state of the CML; and
determining an operating instruction for the CML based on the future corrosion visual state of the CML, the future corrosion severity state of the CML and the future corrosion type of the CML.

2. The method of claim 1, wherein the first part of the input data comprises visual data of the current corrosion state of the CML; and/or
wherein the second part of the input data comprises measurement data of the current corrosion state of the CML.

3. The method of claim 2, wherein the visual data comprises time-series data of images taken from the CML;
wherein the measurement data comprises time-series data of a thickness of the CML; and
wherein a first image of visual data of the CML is associated with a first thickness of the measurement data of the CML;
wherein a second image of visual data of the CML is associated with a second thickness of the measurement data of the CML; and
wherein a timestamp of the first image is older than a timestamp of the second image and a timestamp of the first thickness is older than a timestamp of the second thickness.

4. The method of claim 3, wherein the method further comprises processing at least one of the images to identify at least one region of interest in the image.

5. The method of claim 3, wherein predicting the future corrosion visual state of the CML is based on:
predicting a third image of the CML for a future timestamp;
wherein predicting the future corrosion severity state of the CML is based on:
predicting a third thickness of the CML for the future timestamp; and
wherein the third image is associated with the third thickness.

6. The method of claim 1, wherein the second part of the input data further comprises information on at least one of:
a location of the CML; a component type of the CML; a material type and/or a material grade of the CML; a minimum and nominal thickness of the CML; a short-term corrosion rate of the CML; a long-term corrosion rate of the CML; a corrosion behaviour associated with the CML; a timepoint of an end of product lifecycle of the CML; time-series chemical composition data of a process fluid in contact with the CML; time-series operating data of the CML; design parameters of the CML; and/or an initial fluid phase of a fluid in contact with the CML.

7. The method of claim 5, wherein predicting the future corrosion severity state of the CML is further based on:
predicting a corrosion growth rate of the CML for the future timestamp using at least the second part of the input data;
wherein the third image is associated with the corrosion growth rate.

8. The method of claim 1, wherein the CML comprises an area on pressure static equipment and piping.

9. The method of claim 1, wherein determining the operation instruction comprises:
determining a risk assessment based on the future corrosion visual state of the CML, the future corrosion severity state of the CML and the future corrosion type of the CML; and
triggering an alarm when the risk assessment is above a defined risk threshold.

10. The method of claim 1, wherein determining the operation instruction further comprises:
determining at least one timestamp for a future action for the CML based on the future corrosion visual state of the CML, the future corrosion severity state of the CML and the future corrosion type of the CML.

11. The method of claim 1, wherein determining the operation instruction is done by using a recommendation system.

12. A computer-implemented method for training a first artificial intelligence model, a second artificial intelligence model and a third artificial intelligence model for use in determination of an operation instruction for a corrosion monitoring location, CML, the method comprising:
receiving training data to train the first artificial intelligence model, the second artificial intelligence model and the third artificial intelligence model, wherein the training data at least comprises:
a first part of the training data including visual data of at least one CML, the first part of the training data being used to train the first artificial intelligence model to predict a future corrosion visual state;
a second part of the training data including measurement data of the at least one CML, the second part of the training data being used to train the second artificial intelligence model to predict a future corrosion severity state; and
a third part of the training data including visual data associated with corrosion type data of the at least one CML, the third part of the training data being used to train the third artificial intelligence model to predict a future corrosion type.

13. The method of claim 12, wherein the visual data is represented by time-series data of images taken from the at least one CML;
wherein the measurement data is represented by time-series data of a thickness of the at least one CML;
wherein the visual data is represented by time-series data of images taken from the at least one CML, each image being associated with a corrosion type of the corrosion type data.

14. The method of claim 13, wherein the images of the visual data are associated with a corrosion severity state and are grouped according to the associated corrosion severity state.

15. The method claim 12, wherein the second part of the training data further comprises at least one of a location of the CML; a component type of the CML; a material type and/or a material grade of the CML; a minimum and nominal thickness of the CML; a short-term corrosion rate of the CML; a long-term corrosion rate of the CML; a corrosion behavior associated with the CML; a timepoint of an end of product lifecycle of the CML; time-series chemical composition data of a process fluid in contact with the CML; time-series operating data of the CML; and/or an initial fluid phase of a fluid in contact with the CML.

16. The method according to claim 1, wherein the first AI model, the second AI model and the third AI model have been trained according to the method comprising:
receiving training data to train the first artificial intelligence model, the second artificial intelligence model and the third artificial intelligence model, wherein the training data at least comprises:
a first part of the training data including visual data of at least one CML, the first part of the training data being used to train the first artificial intelligence model to predict a future corrosion visual state;
a second part of the training data including measurement data of the at least one CML, the second part of the training data being used to train the second artificial intelligence model to predict a future corrosion severity state; and
a third part of the training data including visual data associated with corrosion type data of the at least one CML, the third part of the training data being used to train the third artificial intelligence model to predict a future corrosion type.

17. The method according to claim 1, wherein the method comprises determining that new training data is available and training the models using the new input data.

18. The computer-implemented method according to claim 1, wherein the first AI model, the second AI model and the third AI model are implemented respectively by a generative adversarial network, a machine learning regressor, and a machine learning classifier.

19. The computer-implemented method according to claim 1, wherein the future corrosion type is at least one of metal loss, pitting, dent or crack.

20. A data processing device comprising means configured to perform the method of claim 1.

21. A computer program comprising instructions, which when executed by a computer, causing the computer to perform the method of claim 1.
